(19) United States
(12) Patent Application Publication
(10) Pub. No.: US 2009/0059740 A1
(43) Pub. Date: Mar. 5, 2009

(54) WRITABLE ADDRESS LOCATING METHODS AND OPTICAL RECORDING APPARATUS UTILIZING THE SAME

(75) Inventors: Hung-Hsiang Chang, Hsinchu County (TW); Ying-Feng Huang, Chia-Yi Hsien (TW); Shang-Pin Sun, Hsinchu County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/847,563

(22) Filed: Aug. 30, 2007

(51) Int. Cl. G11B 7/00

(52) U.S. Cl. 369/44.11

(57) ABSTRACT

An optical recording apparatus for recording data to an optical storage medium. An optical pickup unit emits a light beam to a recording region of the optical storage medium, and receives the light beam reflected from the recording region. A sled mechanism moves the optical pickup unit in a predetermined direction. A processor obtains a boundary between a recorded region and an unrecorded region on the optical storage medium according to the reflected light beam, and obtains a recording address corresponding to the unrecorded region next to the boundary.

### BACKGROUND OF THE INVENTION

1. Field of the Invention

The invention relates to writable address locating, and more particularly to writable address locating methods and optical recording apparatus for write-once optical discs.

2. Description of the Related Art

In write-once optical disc storages, information is usually recorded by sequentially inner-to-outer recording method. Before information is recorded to the disc, a most recently recorded position of information recorded immediately prior to this recording must first be located. After locating the most recently recorded position, a pickup head is moved to a position having an address adjacent to an address of the most recently recorded position in order to record the information onto the disk seamlessly. Hereupon, the address corresponding to the most recently recorded position is defined as the most recently recorded address (“MRA” for short), the address next to MRA is defined as the next writable address (called “NWA” for short), and the position having next writable address will be defined as the recording start position hereafter. Therefore, when arbitrary information is recorded on the disc, the most recently recorded position of information must be located in advance.

Among the methods of locating the most recently recorded position, one conventional method, using binary search, is shown in FIG. 1, in which the start address is assigned to address A and the end address is assigned to address B (S1). In step S1, The assigned start address can be the address of the most inner track of the inserted optical disc, and the assigned end address can be the address of the most outer track. Next, the region corresponding to the middle address C (=(A+B)/2) is read (S2). Next, it is determined whether data has been recorded to the region corresponding to the middle address C (S3). If the region is blank, no data is recorded, the end address is reassigned to address C, so address B is replaced by address C (S4), before returning to step S2. If the region is not blank, i.e. data has been recorded to the region, the start address is reassigned to address C, so address A is replaced by address C (S5). In this method, the next writable address can be obtained after processing a plurality of loops. However, considerable time is required to obtain the next writable address, with search efficiency depending on the address to be obtained. In addition, since the conventional next writable address locating method detects the recorded data according to the assigned address, the process may be interrupted or fail when the recorded data corresponding to the assigned address is damaged or unreadable, or when the assigned address is not detected.

U.S. Pat. No. 5,706,261 to Udagawa discloses an optical disc recording device in which RF signals reproduced from a write-once optical disc are detected during track jump for detecting the boundary between a recorded region and an unrecorded region on the write-once optical disc. It is known that track jump is performed according to a detected tilt error signal. Thus, the track jump speed is limited because fast track jump speed may cause the tilt error signal undetectable. Inevitably, the inherent constraint of the track jump speed makes the limitation on the speed for detecting the boundary between recorded region and the unrecorded region. Thus, much time is spent for the initial operation, so that information will not be recorded immediately.

### BRIEF SUMMARY OF INVENTION

Writable address locating methods and optical recording apparatus are provided. An exemplary embodiment of a writable address locating method for an optical storage medium comprises moving an optical pickup unit in a predetermined direction, emitting a light beam to a recording region of the optical storage medium, receiving the light beam reflected from the recording region, determining whether data has been recorded to the recording region according to the reflected light beam, obtaining a recording address corresponding to a region where no data has been recorded onto it, and recording new data to the recording region according to the recording address.

Another exemplary embodiment of a writable address locating method for an optical storage medium comprises moving an optical pickup unit in a predetermined direction, emitting a light beam to a recording region of the optical storage medium, receiving the light beam reflected from the recording region, obtaining a boundary between a recorded region and an unrecorded region on the optical storage medium according to the reflected light beam, obtaining a recording address corresponding to the unrecorded region next to the boundary, and recording new data to the unrecorded region according to the recording address.

An exemplary embodiment of an optical recording apparatus for recording data to an optical storage medium comprises an optical pickup unit emitting a light beam to a recording region of the optical storage medium, and receiving the light beam reflected from the recording region, a sled mechanism moving the optical pickup unit in a predetermined direction, and a processor obtaining a boundary between a recorded region and an unrecorded region on the optical storage medium according to the reflected light beam, and obtaining a recording address corresponding to the unrecorded region next to the boundary.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a flowchart showing a conventional next writable address locating method;

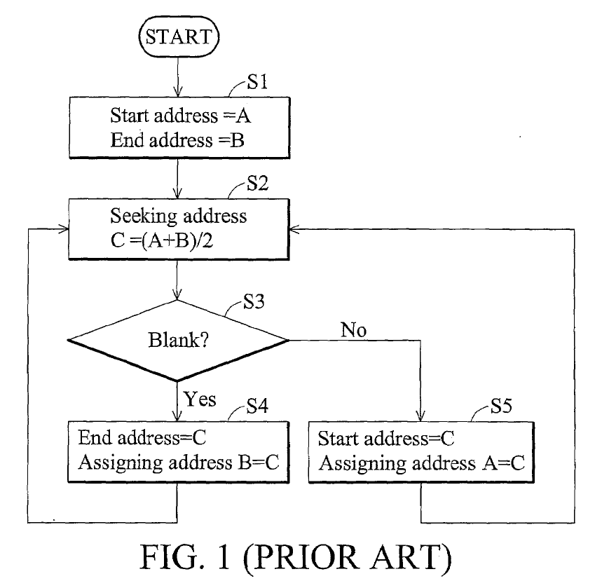

FIG. 2 is a block diagram of an optical recording apparatus according to an embodiment of the invention; and

FIG. 3 is a flowchart showing a writable address locating method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

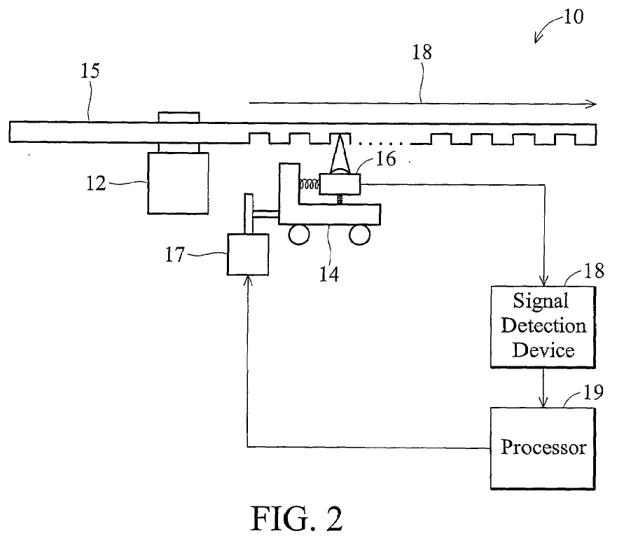

FIG. 2 is a block diagram of an optical recording apparatus according to an embodiment of the invention. The optical disc recording apparatus 10 comprises a disc rotation drive unit 12 including a spindle motor, an optical pickup unit (OPU) 14, a sled mechanism 17, a signal detection device 18, and a processor 19. Optical pickup unit 14 includes a light-emitting element 16, i.e., a laser diode (LD) for illuminating a recording region of the optical storage medium 15, such as a compact disc-recordable (CD-R), a digital video disc-recordable (DVD-R,r DVD+R, DVD+RDL, DVD-RDL), Blu-Ray BD/HD, or the like, with a laser light spot to record and/or reproduce data, and a light-receiving element receiving the light beam reflected from the recording region. Sled mechanism 17 moves optical pickup unit 14 in a predetermined direction. For example, the optical pickup unit 14 can be moved in predetermined direction 18 from an inner region to an outer region of optical storage medium 15. Thus, optical pickup unit 14 sequentially receives the reflected light beams from the inner region to the outer region of optical storage medium 15. Sled mechanism 17 drives optical pickup unit 14 according to a sled index provided by processor 19. In addition, sled mechanism 17 can be moved by a stepping motor. The stepping motor comprises an encoder, and the rotational speed of the stepping motor, or the travel distance of optical pickup unit 14, can be determined based on the output from the encoder. Use of the stepping motor allows the position of optical pickup unit 14 to be set more accurately. However, the invention should not be limited to the stepping motor only, for example, the photo motor or others known by one of ordinary skill in the relevant art should be applied.

The reflected light beam may comprise information of a reproduced RF signal, a differential phase detection signal, a differential push pull signal, a sub-beam addition signal, a phase error signal, or a wobble signal. The information of one of the signals or a combination of the signals can be obtained by signal detection device 18. It is known that the waveforms of the signals conspicuously change when optical pickup unit 14 moves across the boundary between a recorded region and an unrecorded region on optical storage medium 15.

Processor 19 will be noticed of optical pickup unit 14 moving across the boundary between a recorded region and an unrecorded region on optical storage medium 15 according to variation of the reflected light beam. When movement of optical pickup unit 14 across the boundary between the recorded region and the unrecorded region on optical storage medium 15 is detected, processor 19 obtains the position of the unrecorded region next to the boundary, and obtains a recording address corresponding to the unrecorded region according to the wobble signal detected by signal detection device 18. The boundary between the recorded region and the unrecorded region can be obtained according to one or a combination of the reproduced RF signal, the differential phase detection signal, the differential push pull signal, the sub-beam addition signal, the phase error signal, the wobble signal, or according to at least of the same to increase detection accuracy.

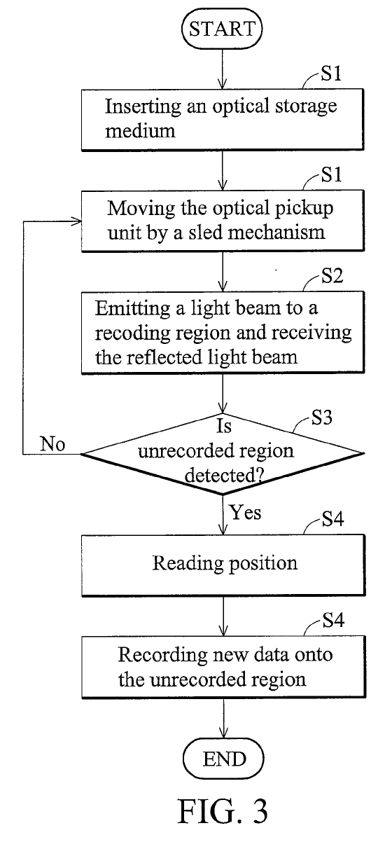

FIG. 3 is a flowchart showing a writable address locating method according to an embodiment of the invention. First, referring to FIG. 2, an optical storage medium 15 is inserted into an optical recording apparatus 10 (S21). Next, an optical pickup unit 14 is moved by sled mechanism 17 through a predetermined direction 18 (S22). During the movement, optical pickup unit 14 emits a light beam to a recording region of optical storage medium 10, and receives a reflected light beam (S 23).

Next, the process detects the reflected light beam, and determines whether unrecorded region is detected according to the reflected light beam (S24). The reflected light beam may comprise information of a reproduced RF signal, a differential phase detection signal, a differential push pull signal, a sub-beam addition signal, a phase error signal, and a wobble signal. The information of the signals can be obtained by signal detection device 18. As mentioned, the waveforms of the signals conspicuously change when optical pickup unit 14 moves across the boundary between a recorded region and an unrecorded region on optical storage medium 15. In addition, if optical storage medium 15 has been recorded before, the recorded region is located on the inner region of optical storage medium 15. Thus, when optical pickup unit 14 moves in the predetermined direction 18 from inner region to the outer region of optical storage medium 15, recorded regions are detected first. When a recorded region is detected, Step S22 is repeated to keep moving optical pickup unit 14 in the predetermined direction 18. As an unrecorded region is detected, the recording address corresponding to the position of the detected unrecorded region is obtained according to the received wobble signal (S25). Thus, new data is recorded to the unrecorded region corresponding to the recording address on optical storage medium 15 (S26). In other embodiments, additional fine search methods may be implemented between steps S25 and S26 to obtain a more accurate recording address. Of course, the optical pickup unit could be designed moving in the predetermined direction from an outer region to an inner region of the optical storage medium.

According to the embodiments of the invention, the boundary between the recorded region and the unrecorded region is detected without reading the address information of the optical storage medium, increasing detection speed. In addition, since reading address of the optical storage medium is unnecessary, detection of the boundary will not be affected when the read address or data recorded thereon is unreadable. In addition, according to the embodiments of the invention, the boundary can be obtained according to one of the reproduced RF signal, the differential phase detection signal, the differential push pull signal, the sub-beam addition signal, the phase error signal, the wobble signal, or according to at least two signals. Generally speaking, the more signals are considered, the more accurate the detection obtained.

While the invention has been described by way of examples and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A writable address locating method for an optical storage medium, comprising:
moving an optical pickup unit in a predetermined direction;
emitting a light beam to a recording region of the optical storage medium;
receiving the light beam reflected from the recording region;
determining whether data has been recorded to the recording region according to the reflected light beam;
obtaining a recording address corresponding to a region where no data has been recorded to the region; and
recording new data to the recording region according to the recording address.

2. The writable address locating method as claimed in claim 1, wherein the optical pickup unit moves in the predetermined direction from an inner region to an outer region of the optical storage medium.

3. The writable address locating method as claimed in claim 1, wherein the optical pickup unit is driven by a sled mechanism.

4. The writable address locating method as claimed in claim 3, wherein the sled mechanism drives the optical pickup unit according to a sled index.

5. The writable address locating method as claimed in claim 3, wherein the sled mechanism is moved by a stepping motor.

6. The writable address locating method as claimed in claim 1, wherein the reflected light beam comprises information of one of a reproduced RF signal, a differential phase detection signal, a differential push pull signal, a sub-beam addition signal, a phase error signal, and a wobble signal.

7. The writable address locating method as claimed in claim 6, wherein the determination of no data recorded to the recording region is according to at least one of the reproduced RF signal, the differential phase detection signal, the differential push pull signal, the sub-beam addition signal, the phase error signal, the wobble signal or combinations thereof.

8. The writable address locating method as claimed in claim 7, wherein no data recorded to the recording region is obtained without reading address information of the optical storage medium.

9. A writable address locating method for an optical storage medium, comprising:
moving an optical pickup unit in a predetermined direction;
emitting a light beam to a recording region of the optical storage medium;
receiving the light beam reflected from the recording region;
obtaining a boundary between a recorded region and an unrecorded region on the optical storage medium according to the reflected light beam;
obtaining a recording address corresponding to the unrecorded region next to the boundary, and
recording new data to the unrecorded region according to the recording address.

10. The writable address locating method as claimed in claim 9, wherein the optical pickup unit moves in the predetermined direction from an inner region to an outer region of the optical storage medium.

11. The writable address locating method as claimed in claim 9, wherein the optical pickup unit is driven by a sled mechanism.

12. The writable address locating method as claimed in claim 11, wherein the sled mechanism drives the optical pickup unit according to a sled index.

13. The writable address locating method as claimed in claim 11, wherein the sled mechanism is moved by a stepping motor.

14. The writable address locating method as claimed in claim 9, wherein the reflected light beam comprises information of one of a reproduced RF signal, a differential phase detection signal, a differential push pull signal, a sub-beam addition signal, a phase error signal, and a wobble signal.

15. The writable address locating method as claimed in claim 14, wherein the boundary between the recorded region and the unrecorded region is obtained according to at least one of the reproduced RF signal, the differential phase detection signal, the differential push pull signal, the sub-beam addition signal, the phase error signal, the wobble signal or combinations thereof.

16. The writable address locating method as claimed in claim 15, wherein the boundary between the recorded region and the unrecorded region is obtained without reading address information of the optical storage medium.

17. An optical recording apparatus for recording data to an optical storage medium, comprising:
an optical pickup unit emitting a light beam to a recording region of the optical storage medium, and receiving the light beam reflected from the recording region;
a sled mechanism moving the optical pickup unit in a predetermined direction; and
a processor obtaining a boundary between a recorded region and an unrecorded region on the optical storage medium according to the reflected light beam, and obtaining a recording address corresponding to the unrecorded region next to the boundary.

18. The optical recording apparatus as claimed in claim 17, wherein the optical pickup unit moves in the predetermined direction from an inner region to an outer region of the optical storage medium.

19. The optical recording apparatus as claimed in claim 17, wherein the sled mechanism drives the optical pickup unit according to a sled index.

20. The optical recording apparatus as claimed in claim 17, wherein the sled mechanism is moved by a stepping motor.

21. The optical recording apparatus as claimed in claim 17, wherein the reflected light beam comprises information of one of a reproduced RF signal, a differential phase detection signal, a differential push pull signal, a sub-beam addition signal, a phase error signal, and a wobble signal.

22. The optical recording apparatus as claimed in claim 21, further comprising a signal detection device detecting at least one of the reproduced RF signal, the differential phase detection signal, the differential push pull signal, the sub-beam addition signal, the phase error signal, and the wobble signal.

23. The optical recording apparatus as claimed in claim 21, wherein the boundary between the recorded region and the unrecorded region is obtained according to at least one of the reproduced RF signal, the differential phase detection signal, the differential push pull signal, the sub-beam addition signal, the phase error signal, the wobble signal or combinations thereof.

24. The optical recording apparatus as claimed in claim 23, wherein the boundary between the recorded region and the unrecorded region is obtained without reading address information of the optical storage medium.
